(19) United States
(12) Patent Application Publication
(10) Pub. No.: US 2007/0043756 A1
(43) Pub. Date: Feb. 22, 2007

(54) Thinking machines

(76) Inventor: Polycarpe Songfack, Sandy, UT (US)

Correspondence Address: POLYCARPE SONGFACK, 10332 SILVER WILLOW DR., SANDY, UT, 84070, US

(21) Appl. No.: 11/204,346

(22) Filed: Aug. 16, 2005

(51) Int. Cl. G06F 7/00

(52) U.S. Cl. 707/102

(57) ABSTRACT

The invention describes Thinking Machines that learn from experience and apply their knowledge to search, discover, generalize and implement complete solutions to common problems. The machine represents a population of entities as Template, a set of properties and value ranges along with a time stamp indicating the time of the last occurrence, a frequency indicating the number of times its has been encountered, and a rating that decreases when it is involved in a problem and increases when it contributes to a solution. The templates provide a framework for identifying entities based on their properties and values. The templates are stored in a Thinking Database specifically designed to support the learning, thinking and problem resolution processes. The templates are updated as more entities are encountered, and evolve to reflect the knowledge that the system has about its environment. The system searches for solutions to a new problem using a novel technique called Scheduling Algorithm. It then uses the templates to generalize the problem into a Concern and creates a Protocol for addressing the Concern in the future without having to research it again. On its own, the machine continuously detects information from its environment and the overall goal of the operator, identifies the entities, resources, problems, then creates a schedule to address the problems, and performs scheduled tasks to provide complete solutions.

### CROSS-REFERENCE TO RELATED APPLICATIONS

None.

### STATEMENT REGARDING FEDERALLY SPONSORED RESEARCH OR DEVELOPMENT

This invention is not the product of a federally sponsored research.

### BACKGROUND OF THE INVENTION

The use of machines, computer programs, and other devices available today normally requires 3 steps. First the operator is trained so as to understand the problem and how to solve it, then learns how to provide the necessary commands that control the device through the user interface, and finally uses the device to solve problems. It is generally obvious that such a machine is just executing a code that was written ahead of time, in a predetermined sequence, and that the operator has full control of the machine. Also, the machine does not understand what it is doing and why, and so, the degree to which it may help the operator is limited.

Several authors have proposed machines for autonomous learning. In the U.S. Pat. No. 4,930,071, filed May 29, 1990, Method for integrating a knowledge-based system with an arbitrary database system, the author proposes mapping between an application relational database of arbitrary structure and an application knowledge base. Another prior art is the Autonomous Learning and Reasoning agent, U.S. Pat. No. 5,586,218 filed Dec. 17, 1996, and U.S. Pat. No. 5,852,814 filed Dec. 22, 1998. The author proposes a situation where the machine learns by example or by being taught what to do by an expert in the field. The technique offers a method of selecting a response to a stimulus by adjusting the response so as to provide a better match based on a memory of cases. The limitation of such techniques is that the operator is still expected to know how to solve a problem and only use the machine for retrieving information.

In the Computer system program for creating new ideas and solving problems, U.S. Pat. No. 6,269,356, filed Jul. 31, 2001, and U.S. Pat. No. 6,101,490, filed May 18, 1993, the authors propose a method for generating a solution to a problem expressed in English language by analogy. The computer uses words in the sentence to query the type of problem from one database, and then use that information to access analogous information from a second database. The technique has a major limitation in that there is no method for autonomous generation of the databases based on actual facts. Also, problem solving is confined to an interactive context of answering questions.

Another prior art mainly aimed at processing natural language is the system and method for expert system analysis using quiescent and parallel reasoning and set structured knowledge representation, U.S. Pat. No. 5,995,955, filed Nov. 13, 1999. It describes the storage of data elements in a knowledge base, with entities that represent tangible elements and a corresponding concept in the knowledge base. The system makes abstraction by using a concept that corresponds to an entity, and different concepts may be traversed using common attributes in order to make logic statement and provide an output or a command as a response to an input. It is also an interactive system that responds to the commands of an operator.

Other conversational methods use semantic networks such as the method to quantify abstraction within semantic networks, U.S. Pat. No. 5,937,400, filed Aug. 10, 1999. The approach consists in using a large dictionary stored in a semantic network, where thousands of dictionary entries for symbols are stored as nodes connected by inheritance links that may be created or removed and inheritance links are shifted so that concrete entries always inherit from more abstract entries. Input symbols from the user are matched to dictionary entries, with priority given to entries, which cover a range of concreteness similar to the range covered by the dictionary. These networks provide a method of holding a conversation in an interactive context, and serve computational linguists. They are not oriented towards actually using the information in the system to autonomously devise and implement solution to real life problems.

In the area of adaptive or intelligent control, there are prior arts such as the robust model-free adaptive control, U.S. Pat. No. 6,684,112, filed Jan. 27, 2004. It proposes a method and apparatus for adaptively controlling continuous variables and providing a large user-defined robust range. Like other adaptive or intelligent control techniques, the goal is to be able to adjust a set of operating parameters in response to sudden changes by others and minimize the effect on the system. Such techniques are limited to maintaining an industrial system in a desired state. They do not provide a way gathering knowledge and making decision such as changing the sate of the operation.

There is clearly the lack of machines that can free up operators from the burden to learn, know, or even monitor the process of solving complex problems. Such machines would collect and organize information on their own, generalize ideas, anticipate events, make decisions, devise solutions to problems, implement these solutions and learn from experience.

This invention offers a radical departure from existing art. It describes the Artificial Intelligence machines that acquire knowledge about their surroundings, process and represent it in a form that is suitable for thinking, store it in a special purpose database system, and use it to autonomously devise and implement solutions to real life problems.

### SUMMARY OF THE INVENTION

Thinking machines represent a population of entities as a Template that consists in a set of properties and value ranges, along with a time stamp indicating the time of the last occurrence, a frequency indicating the number of times its has been encountered, and a rating that decreases when it is involved in a problem and increases when it contributes to a solution. Template tables are stored in the Thinking Database along with other tables that contain information about actual entities, the relations between entities and their property values, the problems that they have encountered, and the solutions that have been implemented. Besides the data listed in the Label table containing terms and commonly used expressions, all other tables of the Thinking Database only contains pointers indicating the relations between the elements of Label table, such that in effect, the Thinking Database essentially stores relations instead of data.

To devise the solution of a new problem, the machine uses a Scheduling Algorithm. It consists in a recursive process whereas the last step of solving a problem consists in an action or a transaction to obtain the solution in exchange for a condition. This condition becomes the problem for the remaining segment of the schedule, until a step is reached where the solution of that step only requires a readily available condition or none at all. With the use of templates, problems are generalized into concerns, and solutions are generalized into protocols.

Templates, entities, problems, concerns, and protocols order themselves through the frequency, time stamp and rating information. In addition, the steps of a protocol are such that the output of a transaction at a given step is used as the input for the next step. Therefore, the schedule of the Thinking Machine falls in place naturally without the need to provide any external rule.

The Life Cycle of the Thinking Machine consists in continuously detecting information about the surrounding environment and the overall goal of the operator, then parsing the information to identify entities, resources, problems, establishing the schedule for solving problems, and performing the tasks in turn to provide complete solutions to problems without operator intervention. In the process, all the tables in the Thinking Database are updated such that the machine continuously learn form experience by improving its templates, and addresses recurring concerns using existing protocols when available, otherwise creating new ones. The Life Cycle of a Thinking Machine is a DISP, short for Detect, Identify, Schedule and Perform.

### BRIEF DESCRIPTION OF SEVERAL VIEWS OF THE DRAWING

Table 1. General Structure of the Label Table

Table 2. General Structure of the Property Table

Table 3. General Structure of the Value Table

Table 4. General Structure of the Entity Table

Table 5. General Structure of the Identification Table

Table 6. General Structure of the Problem Table

Table 7. General Structure of the Concern Table

Table 8. General Structure of the Experience Table

Table 9. General Structure of the Protocol Table

Table 10. General Structure of the History Table

FIG. 1. Recursion Algorithm for calculating the factorial of an integer

FIG. 2. Scheduling Algorithm for solving a new problem

FIG. 3. DISP or the Life Cycle of a Thinking Machine

### DETAILED DESCRIPTION OF THE INVENTION

Introduction

Virtually all computer programs and other machines available today are designed with the understanding that human operators would have complete control of the device, and provide commands through a Graphical User Interface or other system. The machines would then execute a known program to perform the tasks requested in a predetermined order. Their use generally requires 3 steps. First, operators are trained for a certain time so as to understand the problem and how to solve it, then they learn how to use the device, that is how to provide the necessary commands that control the device through the user interface, and finally, they use the device to help solve problems.

A Thinking Machine is a device, computer or other machinery that provides complete solutions to common problems by learning from experience, inferring from similar problems or using experimentation. In practice, situations dictate most decisions because of the problems that they pose and the resources that are available. Thinking Machines understand situations and are is essentially free to make their own decisions, establish and update their own schedule and perform the tasks in the scheduled order.

Implementations of these machines result in applications that are very easy to use because the owner would not need to know how to solve the problem or how to use the device. In fact the machine would be able to judge the level of knowledge of the operator and would offer and explain different approaches to solving a problem. It would also be able to provide a complete solution to a problem, either from scratch or from any point along the way. It would understand and explains what it is doing, and why it is doing it the way it has chosen.

The design provided in this invention is not tied to a specific application, as it applies to the solution of all problems that require a certain amount of thinking. These are problems generally handled by a human operator because standard computer programs would not understand.

Thinking Machines have a plethora of applications including web servers that foil cyber-crime, agents that build and manage web portals and implement e-commerce on their own, search engines that understand the meaning of search queries, applications that respond to customer service requests, perform office tasks such as reading and replying to email, writing and mailing letters and other documents, helpers that provide training and testing, process control devices that use experience to manage plant operations, vehicle that elude theft, vehicle repair experts, assistants that suggest or monitor medical treatments and patient progress, nannies that track children daily location, routine and enforce their safety without tempering with their privacy, devices that oppose the operator in a computer game, hold meaningful conversations with human subjects, drivers for the robots that operate in household, office, harsh environments, battlefield, and in space.

Templates

Thinking machines use templates to encode the information about populations of entities. A template consists in a set of properties and value ranges, along with a time stamp indicating the time of the last occurrence, a frequency indicating the number of times its has been encountered, and a rating that decreases when it is involved in a problem and increases when it contributes to a solution. The combination of frequency, time stamp and rating information provides a mechanism for ordering templates, entities, properties, values, problems, and protocols.

A template is an abstract representation of a population of entities that have the same set of properties, and values that fall in the value ranges of the template. In other words an entire population of entities, no matter how large is encoded into one single template.

Templates help identify entities by comparing the properties and values of the entity to the property set and value ranges of templates. They are also updated when the device encounters entities of that template. The entities provide property values that may already exist in which case the frequency and timestamp of the property, and its value are updated. When the value is new, it broadens the range of values of that property. In effect, templates help identify entities, but entities actually help define the templates. Even though the entire population is encoded into one template, its takes into account the contribution of each entity.

Templates are generally not defined from scratch. The definition of a given template is normally based on that of a broader one, whereas the more specific template only tracks the properties and values falling within its definition.

Unless one actually retrieves the current representation of a template from the machine, or follows the device throughout its Life cycle, it is not possible to know exactly how a given template would be like. Even though different machines and the operator may agree that they are referring to the same template, or that an entity is of a given template, the agreement is based on the template definition that is not well known, always evolving, and more importantly, is represented differently by the parties. However, different machines may compare or synchronize their templates.

Any concept is actually represented by a template, even if it is very basic, or an intrinsic like a number or a color that has only one property and one value which are itself. To that extent, the properties of a given template are themselves templates. That ambivalence of properties does not constitute a problem because properties values are generally provided in sets, and the device would know the template that the set of properties and values are describing. One can say that the context helps define the template that is being referred. In other words, the template is always implied by the whole set of attributes. Confusions would be possible only when the situation is itself confusing.

Templates are the way the device represents the outside world internally. It is not necessarily the way the outside world is, but it is the way the device knows it. Since templates are updated during the whole Life Cycle of the device, they do not represent the outside world as it is currently or as it has been throughout the times, but the way the device has observed it over its own Life Cycle. That knowledge is not accurate or complete, it is just relevant.

A template enables the device to generalize problems that occur with one entity into concerns that may potentially arise with the entire population of entities sharing the template. When a schedule for solving a new problem is established, it is also generalized into a protocol by substituting the entities that take part in the schedule with their underlying templates. Templates, concerns, and protocols are small elements of thought in the sense that they are used to conceptualize entities, problems, and solutions.

Thinking Database

The Thinking Database stores the elements of thoughts: templates, concerns, and protocols, along with the actual entities, problems, solutions, and history. Any modern Relational Database Management System (RDMS) can be used as engine for the Thinking Database but it involves specific table structures.

The device uses data to represent and encode the entities that it encounters and the solutions to problems that it has solved. The data is processed in terms of labels, which are individual terms and commonly used expressions. In the case of multimedia applications, the corresponding samples would be the labels. Those labels are the only real tangible data that is in use, and they are stored in the Label Table. The labels are the way things are called, and they may be easily translated into other languages or any coherent set of symbolic representations while keeping the other tables, as well as the thinking process, and the operation of the machine unchanged.

Besides the data listed in the Label Table of all terms and commonly used expressions, other tables of the Thinking Database only contain pointers that indicate the relations between the elements of the Label Table, such that in effect, the Thinking Database essentially stores relations instead of data. Indeed an implementation of the machine may spread the data for convenience.

There is no repetition or redundancy in the data, or relations. Instead, there is timestamp, history, frequencies and ratings that depict the relative importance, freshness, or usefulness of certain relations. There are also pointers that indicate synonyms, or labels that may be interchanged for the same meaning. The information is stored in a way that it may be conveniently retrieved and analyzed to make decisions. Conventional databases or RDMS are the most advanced tool available at this time for such a purpose. However, it is important to mention that conventional databases are not well suited for the job and need to be used in a special way in order to build Thinking Databases.

The main problem with RDMS is that they do not allow for dynamically extending and labeling of the columns. They were devised for storing data in a context where all the properties of a given category of objects are known ahead of time. The tables are defined ahead of time with column names that represent the attributes being stored, and the application that uses the table must specify the column names in the queries that manage the data. Such constraints pose a major problem when the application does not know everything about the entities that it will encounter. The way to circumvent these limitations is to arrange the tables vertically, and use one column for the property ID and another for the value ID.

Another problem with RDMS is that they are optimized for storing data. The rows and columns of such databases holds actual data, like words, numbers, files and such. Thinking Databases in the other hand mainly keep track of relations, and do not normally expect redundancies and repetitions. In general any piece of data is in the system only once. Relations grow in importance when they are often used, highly rated, and they are also more readily available when they were recently retrieved or stored. Such factors will be tracked in extra columns, like frequency, ratings, and time stamp that would then be used to sort the data.

The Thinking Database contains any combination of the following tables that may vary depending of the application:
The Label Table

It is a list of all the terms and commonly used expressions. Each of these terms has a unique ID that will be used to track its relations in the other tables. The other columns are the frequency of use, ratings that are derived from the Problems and Solutions Tables, and time stamp that indicates its freshness. All the terms that are used for template names, property names, values, problems, solutions are listed in the Label Table. In general, information is always added to this table and never removed. Table 1 below shows the general structure of the Label Table.

TABLE 1
General Structure of the Label Table

| | | | | |
|---|---|---|---|---|
| Label ID | Label Name | Frequency | Rating | Timestamp |

The Property Table

The first table used for representing the template information is the Property Table. It is the list of known properties of a template along with the other auxiliary columns. Once an entity is identified to be of a given template, the known properties are updated, and depending on the circumstances, the device may inquire about the properties that were not specified. Table 2 shows the general structure of the Property Table

TABLE 2
General Structure of the Property Table

| | | | | |
|---|---|---|---|---|
| Template | Property | | | |
| ID | ID | Frequency | Rating | Timestamp |

The Value Table

The second table needed for representing the template information is the Value Table. It is the list of known values of each property along with the other auxiliary columns. While updating the properties of a given template, the specified values are updated at the same time. In effect, the Property and Value tables are just a way of using conventional RDMS to store the templates. The templates are made of properties, value ranges, frequencies, ratings and timestamp. In practice, the Template ID, and Property ID of the Value Table shown in Table 3 can be represented by a combined index.

TABLE 3
General Structure of the Value Table

| | | | | | |
|---|---|---|---|---|---|
| Template | | | | | |
| ID | Property ID | Value ID | Frequency | Rating | Timestamp |

The Entity Table

The Entity Table tracks the last known state of familiar entities. When a familiar entity changes state, that is, the value of one its property changes, the old value is moved into the History Table. Over time, the past values define a range, and the entity can be viewed as a template for each of its states. Table 4 below shows the general structure of the Entity Table.

TABLE 4
General Structure of the Entity Table

| | | | | | |
|---|---|---|---|---|---|
| Entity ID | Property ID | Value ID | Frequency | Rating | Timestamp |

When a new entity presents important properties or values that are clearly different from that of available templates, it may be used to define new template, as long as other such entities become frequent in the system. Otherwise, the isolated entity will be used or observed and kept for a while then discarded.
The Identification Table

The Identification Table is to some extend the inverse of the Entity table. It tracks the property values in terms of the entities they belong to. It is the first table that is queried for identifying entities, by recognizing their values. Table 5 below shows the general structure of the Identification Table.

TABLE 5
General Structure of the Identification Table

| | | | | |
|---|---|---|---|---|
| Value ID | Entity ID | Frequency | Rating | Timestamp |

Entities are transient in the sense that at some point the information about an individual entity may be deleted from the Entity Table and the Identification Table to clear up space. However, the trace of that entity would remain in the Template Tables because templates are permanent.
The Problem Table

The Problem Table lists the problems that have occurred with known entities. A problem is the need to change the state of an entity by setting the value of a given property to a desired value. Any problem may be expressed in terms of the entity that poses problem, the property involved and the value that would resolve it. When an entity poses a problem, the rating of the entity decreases in the Entity Table and Identification Table. The rating of the property involved and that of the current value decrease in the Template Tables. The rating of the desired value remains unchanged until the problem is solved. The general structure of the Problem Table is shown on Table 6.

TABLE 6
General Structure of the Problem Table

| | | | | | |
|---|---|---|---|---|---|
| Problem | | Property | Desired Value | | |
| ID | Entity ID | ID | ID | Success | Timestamp |

The Concern Table

The Concern Table is a list of potential problems that are likely to occur with entities of a given template. The general structure of the Concern Table is shown on Table 7.

TABLE 7
General Structure of the Concern Table

| | | | | | | |
|---|---|---|---|---|---|---|
| Concern | Template | Property | Desired | Fre- | | Time- |
| ID | ID | ID | Value ID | quency | Success | stamp |

The main difference between a problem and a concern is that the problem is specific to an entity meanwhile a concern is applicable to the entire population that shares a common template. The Problem Table tracks the Entity ID while the Concern Table tracks the Template ID. Problems listed in the Problem Table are transient, just like entities. However, problems are permanently encoded in the Concern Table, just like entities are permanently encoded in the Template Table. Concerns are templates for problems.
Experience Table

The Experience Table lists the solutions that have been implemented for actual problems. It tracks the actual entities that were involved in the resolution of real problems. Table 8 shows the structure of the Experience Table.

TABLE 8
General Structure of the Experience Table

| | | | | | | | |
|---|---|---|---|---|---|---|---|
| Problem | Solution | Step | Entity | Property | Value | | Time- |
| ID | ID | ID | ID | ID | ID | Success | stamp |

When an entity successfully takes part in the resolution of a problem, the rating of the entity increases in the Entity Table and Identification Table. The rating of the property involved and that of the value obtained increase in the Template Tables. Also, in the end the rating of the final value that solves the problem successfully increases in the Template Tables. The steps necessary for solving a new problem are obtained using the Scheduling Algorithm described later in this document.
Protocol Table

The Protocol Table keeps tracks of each step included in the different ways of addressing a concern, the templates involved, the properties and values that are sought and the success rate. Table 9 shows the general structure of the Protocol Table where the Concern ID and Protocol ID column may be replaced by a combined index.

TABLE 9
General Structure of the Protocol Table

| | | | | | | | |
|---|---|---|---|---|---|---|---|
| Concern | Protocol | Step | Template | Property | Fre- | Suc- | Time |
| ID | ID | ID | ID | ID | quency | cess | stamp |

A protocol provides a way of generalizing a solution implemented for one entity to the entire population. The Experience Table tracks the problems, and the entities involved in the solution while the Protocol Table tracks the underlying concerns and templates. Protocols are templates for solutions. When the machine encounters an entity, it uses the Identification Table, the Template Table, and the Entity Table to identify the entity and its underlying template. Then it uses the Concern Table to find out all the problems that the entity may cause. Finally, it uses the Protocol Table to determine all the solutions that the entity may provide.
History Table

The value of the property of an entity prior to a change is recorded in the History Table, along with the entity that caused the change, the problem that was being addressed and the time stamp of the action or transaction. It provides a mechanism for keeping tracks of the different states of entities over time. When an entity often changes states, the data from the history table might be processed to build a template for its different states. Table 10 below shows the general structure of the History Table.

TABLE 10
General Structure of the History Table

| | | | | | |
|---|---|---|---|---|---|
| | | | | Problem | |
| Entity ID | Property ID | Value ID | Author ID | ID | Timestamp |

The Label Table is the only one in the Thinking Database that stores real tangible data. The later may be of different types like numeric, characters, words, files, multimedia fragments, binary objects, and others. It is necessary to implement a data conversion module, or divide the table so that each component stores only one data type because the Thinking Database is built over standard RDMS that do not allow for mixing data of different types in the same table column.

Beyond the Label Table, the data type does not matter since the remaining tables only track relations. Notice that actual data may migrate from the Label Table to other tables for simplicity, without much effect on the operation of the machine. Also, given the similarity of their structure, other tables can be merged with an additional column that indicates the nature of the relation, such as property, value, entity, template, identity, and so on.

Parsing Information from Operator and Surrounding Environment

There are numerous techniques that are effective for obtaining and parsing information from the operator and the surrounding environment. These include web forms, Graphical User Interfaces (GUI) or other such systems, extensible Markup Language (XML), Pattern Matching or Regular Expressions, Imaging and Sound Processing Techniques and others. This invention does not provide techniques for obtaining and parsing information from the operator and the surrounding environment. It is assumed that the most suitable ones would be implemented.

The performance of the above techniques drastically improves when combined with the information from the Thinking Database. In effect, once some of the properties are identified, the number of possible templates becomes fairly limited, and from that point, the system starts scanning the environment for specific data. For instance, if there is a possibility that the entity is a purchase order, the system would start scanning it for properties such as customer name, address, phone number, merchandise line items etc. Likewise, if a scene forms a battlefield, the system would reduce it to the coordinates and number of related properties like troops, tanks, weapons, and such, instead of trying to process the whole image as one.

Template Oriented Programming

The most advanced computer technique currently used for writing applications is called Object Oriented Programming. It defines classes that are abstract objects, and then create real objects that are instances of the classes. These objects have attributes and methods that are well defined by the class. The technique deals with situations that are well known in advance and may be described by a number of predetermined rules. The resulting systems execute predictable commands that are programmed ahead of time. This technique presents several shortcomings when applied to programming Thinking Machines. For example, a class is well known and well defined at compile time and there is no way of extending it or generating a new one at run time. Also, objects are created based on the class, and have no influence on the class at runtime. There is no mechanism for gathering, improving and utilizing new information.

A Thinking Machine deals with real life entities that may, or may not be known ahead of time, and their definition can evolve. Also, depending on the circumstances, entities may reveal a property that was not known so far, and thus, an entity helps define its underlying template, just like the template gives certain expectations on the entity, in a two-way relationship. Also, without a detailed inspection of the entire Thinking Database, it is generally not possible to predict what the thinking machine would be doing next. It has the ability to make its own decisions and create its own schedule.

Template Oriented Programming extends Object Oriented Programming by defining a set of methods that are used to easily handle entities, templates, problems and solutions, concerns and protocols. These methods are implemented through queries to the Thinking Database using the Standard Query Language (SQL), or any equivalent approach. Although not required, there would be a layer of code encapsulating the Thinking Database, so that the rest of the system does not need to keep track of the data. The technique also introduces the Scheduling Algorithm, a mean by which the machine establishes its own schedule for performing its tasks, and alters the schedule based on what is encountered on the field. Templates and entities would normally implement the following methods:

getPropertySet

All templates would have the method getPropertySet that returns all the properties that a template is known to have at a given time. The property set is readily available for templates that exist in the Thinking Database. Since entities are instances of templates, the getPropertySet method also applies to entities, but it does not have a unique implementation. When the template of an entity is known, the method is the same as that of the template and the property set may be obtained from the Thinking database. Otherwise, the property set is normally obtained by parsing the data supplied to the system.

The property set is central in creating a new template. It is also very useful when identifying an entity and its purpose. Once the property set is known, The device would then be interested in finding the values for each property and testing against known entities, in order to identify a new entity.

setPropertySet

The setPropertySet method would be used when an entirely new template is to be created. If a template differs from another only by a few properties, or a different range of property values, the most specific template would use the general one as a base and only store the modifications.

addProperty

By design, templates are never fully known. A new property can always be discovered at some point or supplied by a new entity. In that case, other entities of that template may be checked for the value or the relevance of the new property, which is a combination of the frequency, timestamp and rating. The relevance of the new property will evolve over time.

getPropertyValue

This method would be implemented at the entity level to find out the value of a given property. Obtaining the result is simple when the entity is already in the Thinking Database. However, when the entity is new, the values would generally be obtained from parsing the data supplied to the system.

setPropertyValue

This method would be used to change the state of an entity in the Thinking Database, by updating the value of a given property. The update would affect all the relevant tables.

getProtocol

This method would be applied to problems. The result would be the list of steps necessary for solving the problem and the templates, actions or transactions that are necessary at each step. Normally a problem would have several protocols that can be represented graphically as a tree, as the initial steps are different, but they all converge towards the same final step that is at the root of the problem.

In general, one does not know the specific protocol that would be use because things are self-arranged in the Thinking Database, based on their relevance. In the case where there is no known solution to the problem, the machine would use the scheduling algorithm to generate a new protocol.

updateSchedule

The protocol for solving a problem is only defined conceptually, that is, at each step an action or a transaction is performed over an entity of a known template. However, the specific entity is not known. The protocol becomes a schedule when the suitable entities are found and the device can proceed with initiating the actions or transactions. The entities that are likely to be highly successful at each step of the schedule are obtained from the Experience Table and the Entity Table. Normally, there would be other items in the overall schedule already, and the priorities would fall in place naturally because the problems have different ratings, and the conditions for a given step are used in subsequent steps.

request

The system makes a request to entities for changing a property to the value specified in the request. The result is normally a success, signifying that the action is performed as requested, a deny meaning that the action has failed with no further information, or as it is more often the case, a condition that is required for performing the request. A successful request is an action.

trade

When a request for a change is responded by a condition, the action can be performed provided the condition is met. That constitutes a trade or a transaction of the condition against the requested action.

Scheduling Algorithm

Establishing a schedule is made easy once the problem is known, and protocols exist in the Thinking Database, along with experience records of solving the problem in the past. In that case, creating a schedule consists in replacing the template at each step of the protocol by an entity likely to be successful for completing the action or transaction.

When the problem is new, there is no known protocol. The device basically proceeds by experimentation. It first makes a requests on the entity that is subject to the problem, and in most case, the response would be in the form of a condition. The condition is actually just a new problem that can be solved as in the previous step by finding an entity in the system that has the property value that constitutes the condition. The solution to the new problem itself becomes a problem until the condition requested is readily available or none is posed.

When the machine arrives at the point where no condition is required, it may then proceed with transactions, in the reverse order of the requests that were attempted initially. These steps and the entities involved define the schedule for solving the problem at hand. Solving the problem consists simply in proceeding with each step in turn.

To illustrate the technique, let's consider the Breakfast Problem whereas the human operator needs breakfast. The machine first requests that the operator has breakfast, and the operator responds by a condition such as pancakes. It's now known that the last step will consist in the operator having pancakes for breakfast, but for now, the new problem consists in finding an entity that would provide pancakes. The initial problem is solved temporarily, however there is now a new one that needs to be solved. The machine experiments by checking all its entities one at a time and it turns out that the local restaurant has pancakes. The scheme may continue such that the final schedule would be something like:

Step1. Entity: local ATM. Trade operator PIN and card against cash.

Step2. Entity: local restaurant. Trade operator cash against pancakes.

Step3. Entity: operator. Set breakfast property to local restaurant pancakes.

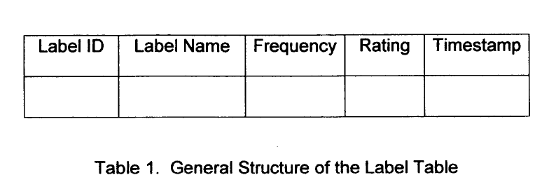

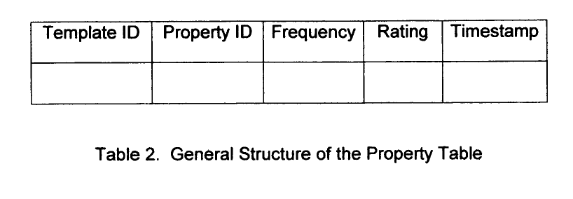

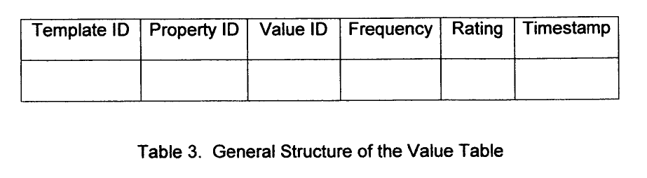

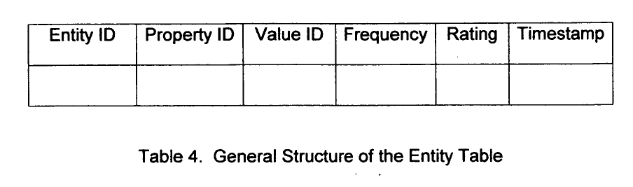

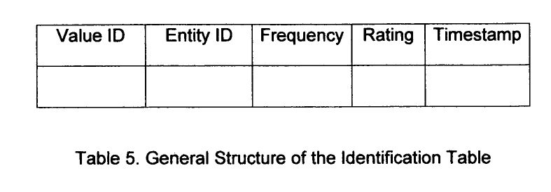

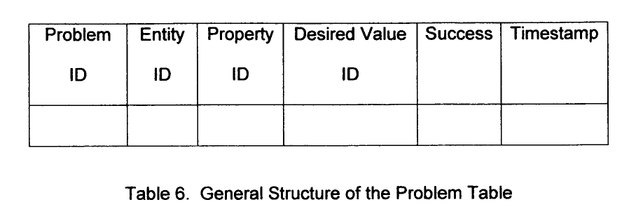

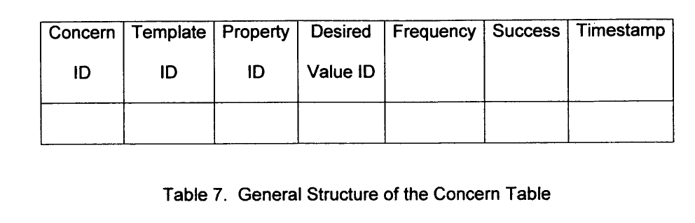

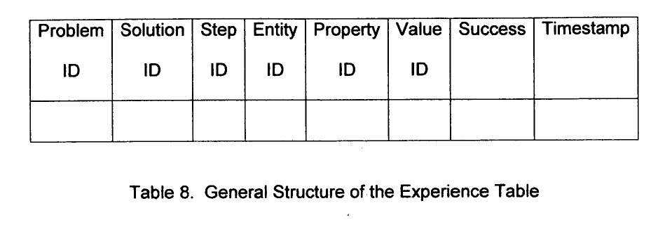

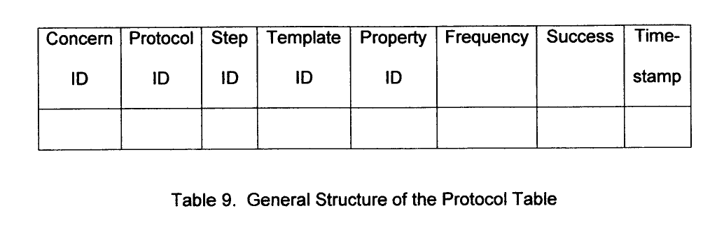

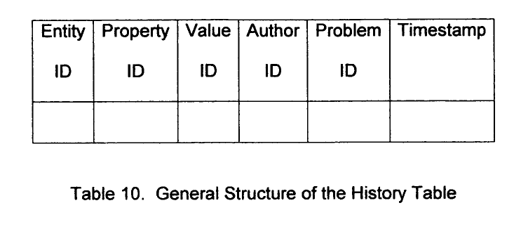

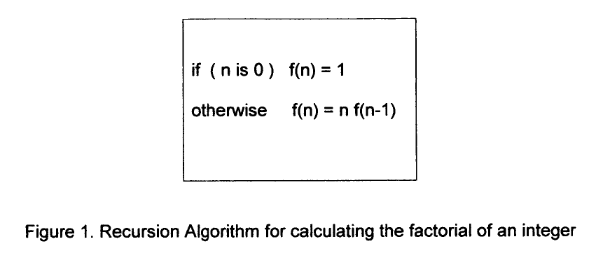

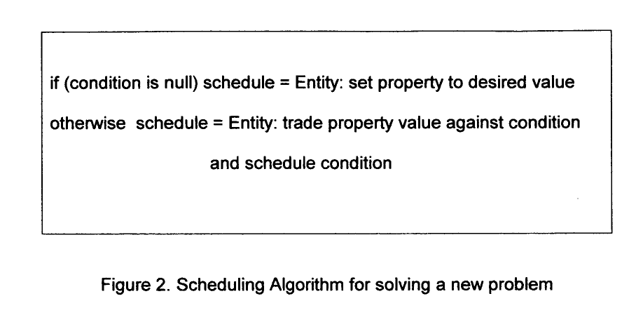

The Scheduling Algorithm is a generalization of the programming technique known as recursion. It is a function that calls itself in a loop until a certain test is successful. Likewise, the Scheduling Algorithm solves a problem by replacing it by a different problem, with the hope that at some point in the process, the scheme would eventually yield a problem simple enough to be solved without condition, or one that is already available. FIG. 1 shows the diagram of the Recursion algorithm for calculating the factorial of an integer. FIG. 2 shows the scheduling algorithm for finding out the solution of a problem.

[image]

[image]

A schedule tells which entities are going to be involved in the solution of a problem, the exact condition (desired property value) to be obtained at each step and used for the next transaction. Establishing a schedule involves finding out which entities are suitable for taking part in the transactions or the requests. Indeed the last entity in the schedule is the source of the problem.

When a problem occurs with a given entity, it is really a unique problem that only involves the entity. However, the problem is generalized into a concern because all entities of that template may potentially have the same concern in the future. Also, the same problem may occur later but there is no guaranty that the exact same entities will be used in the schedule, as each may be replaced with a more suitable one of the same underlying template. Without a close analysis of the all the data in the Thinking Database, one cannot tell for sure what a Thinking Machine would be doing next.

When an entity of a given template can participate in one of the steps of a schedule, any entity of that template may potentially participate in that step, as it is known to have a certain amount of the desired property. Therefore, the schedule is generalized into a protocol by substituting the entities by their underlying templates. The protocol for the Breakfast Concern derived from the previous example is as follows:

Step1. Template: ATM. Trade PIN and card against cash.

Step2. Template: restaurant. Trade cash against pancakes.

Step3. Template: human. Set breakfast property to pancakes.

It is possible that a protocol may not lead to a schedule due to the lack of suitable entities, and a schedule can fail because an entity does not deliver the expected value. In any case, things may go wrong for a variety of reasons. Normally, another protocol may be implemented until all the possibilities are exhausted, and a new one may be devised.

Life Cycle of Thinking Machines

Thinking Machines solve problems using past experience or experimentation. In their Life Cycle, they Detect, Identity, Schedule, and Perform (DISP). When an input from the sensors or the user interface is detected, the machine parses it and obtains individual terms or labels. These are compared to the data in the Label Table, and it is updated accordingly.

The next step is to identify the entities and their underlying templates. The Identity Table is very useful to this effect because it readily yields the entities that were last seen with the property values (labels) observed. All other tables may be checked as needed. Once a few properties are identified, the Identification process becomes very effective because properties and value ranges are tied together in sets to form templates. Thus when some of the important properties of a template are found, the machine actively searches for the remaining ones.

The Identity, Template and Entity tables are updated at the Identification stage. The Template Tables are always updated and once data gets it to those tables it normally stays permanently. In contrast, the data in the Identification Table and Entity Table might be transient.

In most cases, the entities from the Identification stage might express a problem explicitly. In other cases, the value of each property may be checked against the Concern Table and Experience Table in order to identify actual problems, threats, as well as resources. The resourceful entities might be substituted in the current ongoing schedule in order to improve the chances of success of the scheduled tasks. The Problems and Concern Tables are also updated at the Identification stage.

The next step is to use the Protocol Table to obtain a protocol for solving each of the problems. It is relatively easy to solve a problem when the protocol is available. The protocol defines the template that is needed at each step, and the property that should be set to the desired value. The system locates the entities that have the desired property value and are highly likely to contribute to a successful schedule based on the frequency, timestamp, and rating information.

When a problem has never been solved before, the system researches the solution and derives the corresponding protocol using the Scheduling Algorithm. It takes more resources because the machine proceeds by try and error, making requests for the desired property value on populations of each template in turn.

The schedules for solving each of the current problems are merged with the on-going overall schedule. In doing so, tasks are reorganized depending on the relevance of each problem, as long as the steps of individual schedules are still in the proper order, as they cascade from one to the other.

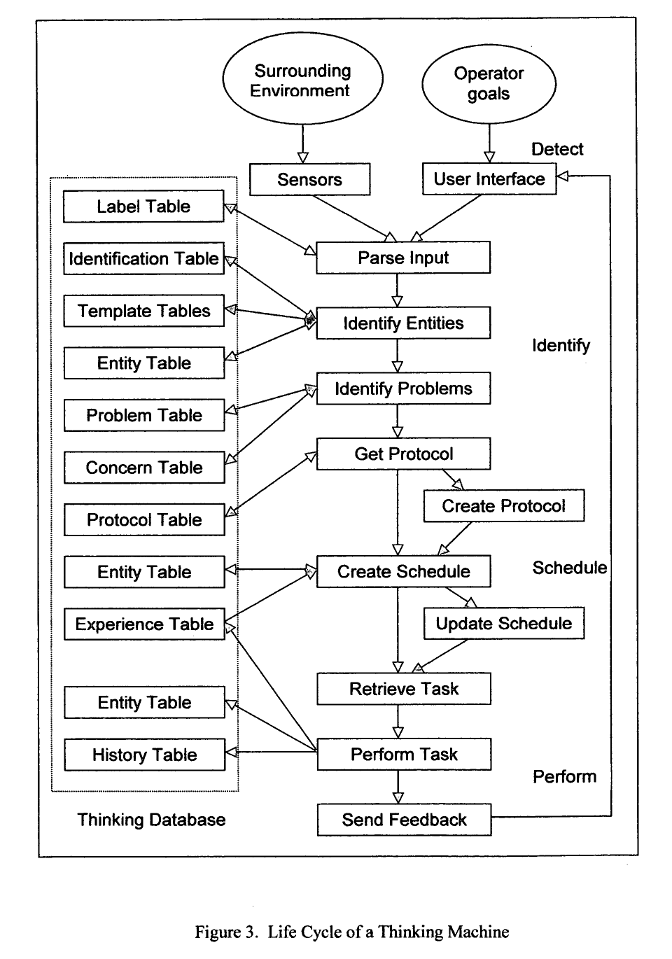

The machine then proceeds into performing the tasks in the overall schedule to provide complete solutions to problems. Whenever a problem is solved, the machine updates the Experience Table to record the solution. It also updates the History Table with the previous state of the entities that have changed. Finally, it updates the other tables with the current state of the entities, and changes the frequency, timestamp, and ratings as needed. The diagram of FIG. 3 below shows of the Life Cycle of a Thinking Machine.

[image]

I claim:

1. A method for encoding entity information into templates whereas:
(a) A template is a set of properties and value ranges along with time stamp information indicating the time of the last update, a frequency indicating how often it has been encountered, and rating indicating how often has presented a problem, or participate in a successful solution.
(b) A template helps identify related entities by comparing properties and values of entities with the property set and value ranges of the template. Once a few properties are identified, it becomes obvious what other properties are expected because they are tie together in a set by the template definition.
(c) The property set and value ranges of a template are extensible and individual entities of a given population help define the template by extending the property set and providing the property values.
(d) Templates are used to generalize a problem that has occurred to an entity as a potential concern applicable to all entities of the corresponding template.
(e) A solution to a problem encountered with an entity is expressed as a schedule of actions and transactions with specific entities, and then generalized as a protocol by replacing the entities by the corresponding templates.

2. A Thinking Database specifically designed to support the learning, thinking, and problem resolution process. It contains any combination of the following tables whereas each record may have a timestamp, frequency or rating as needed:
(a) The Label Table lists of all the terms and common expressions used for template names, property names and values, entity names, problems, actions and transactions, solutions, protocols or to designate items in the surrounding environment, along with an ID.
(b) The Property Table lists all the properties of each template known to date.
(c) The Value Table is the list of known values of each property. Along with the Property Table, it provides the Template information.
(d) The Entity Table tracks the last known state of familiar entities.
(e) The Identification Table is to some extend the inverse of the Entity table. It tracks the property values in terms of the entities they belong to. It is the first table that is used for identifying entities, by recognizing their attributes.
(f) The Problem Table is a list of actual problems that have occurred with known entities.
(g) The Concern Table is a list of potential problems that are likely to occur with all entities of a given template.
(h) The Experience Table is the list of solutions to problems that have been implemented.
(i) The Protocol Table keeps tracks of each of the steps involved in the different ways of solving a problem, the templates that are involved in the solutions, the property that is sought at each step and the success rate.
(j) The History Table lists the actions and transactions that have taken place, their author and the objective being pursued.
(k) The Thinking Database tables may be stored in a RDMS, XML files, or any suitable system.
(l) The Template Oriented Programming technique may be use to extend the standard Object Oriented Programming technique by providing convenient methods to easily identify entities, templates, problems, concerns and update the related information. These methods are implemented as queries to the Thinking Database or an equivalent technique.

3. A Scheduling Algorithm for researching the solution of a problem and expressing it as a schedule, then generalizing it into a protocol whereas:
(a) The objective of the Scheduling Algorithm is to establish a schedule of actions and transactions that will be performed with known entities in order to solve a given problem.
(b) The Scheduling Algorithm consists in a recursive process where the last step of the schedule would be to perform a transaction with a known entity to obtain the solution in exchange for a condition, and then establish the schedule for obtaining the condition by repeating the process, with the condition as the new problem. The process ends when a step is reached where the solution for that step only requires a condition that is readily available or none at all.
(c) Solving the problem consists in performing the tasks (transactions or actions) in each step of the schedule, knowing that the result of a given step would be used as input to the next.
(d) The problem and the entity at its source are stored in the Problem Table of claim 2 (f), the steps and entities involved in solving the problem are stored in the Experience Table of claim 2 (h), the states of entities resulting from solving the problem are updated in the Entity Table of claim 2 (d), and the Identification Table of claim 2 (e), and History Table of claim 2 (j).
(e) A problem with a known entity is generalized into a concern that may be addressed for all entities of the corresponding template, as indicated in claim 1 (d), by replacing the entity at the source of the problem by its template, and storing the resulting concern in the Concern Table of claim 2 (g).
(f) The schedule for solving the problem is generalized as a protocol for solving that category of problem, by replacing the entities at each step by their corresponding template as indicated in claim 1 (e), then storing the protocol into the Protocol Table of claim 2 (i).
(g) Actions and transactions that occurred in the surrounding environment either by themselves or caused by the system while solving problems resulted in the change of the state of the entities involved, and the changes, their source, and the reason for the change is saved in the History Table of claim 2 (j). The currently known state of each entity is tracked in the Entity Table of claim 2 (d), Identification Table of claim 2 (e), and encoded in the Template Tables of claim 2 (b) and (c).
(h) In their Life Cycle thinking machines Detect, Identity, Schedule, and Perform (DISP) to solve problems. They continuously detect information about the surrounding environment and the overall goal of the operator, then parse it to identify entities, templates, goals, problems, update the Thinking Database accordingly, generate schedules using protocols, then perform scheduled tasks to provide complete solutions to common problems.
(i) After parsing the input, the property values are used to update the Label Table of claim 2 (a), then checked against the Identification Table of claim 2 (e), the Entity Table of claim 2 (d), the Property Table of claim 2 (b), and the Value Table of claim 2 (c), to identify each entity and its template.
(j) Once the entity and its underlying template are identified as indicated in the above claim 3 (i), the Concern Table of claim 2 (g) is checked to determine whether the entity poses a problem.
(k) A problem is solved by retrieving the most relevant protocol from the Protocol Table of claim 2 (i), then implementing it into a schedule by substituting the template at each step by an entity of that template, that is the most suitable for providing the desired property value. When such a problem has never been solved before, or when existing protocols do not lead to a successful solution, the system uses the Scheduling Algorithm of claim 3 (b) to research a new solution.
(l) The Experience Table of claim 2 (h), History Table of claim 2 (j), are checked to find out if the entity would be more effective for a given task than a scheduled entity of the same template. Then the machine retrieves tasks from the overall schedule and performs the corresponding action or transaction to provide complete solutions to problems and update the Thinking Database tables of claim 2 (b) to 2 (j) as needed.
